(19) United States
(12) Patent Application Publication
(10) Pub. No.: US 2026/0154897 A1
(43) Pub. Date: Jun. 4, 2026

(54) Uncertainty-Aware Inference of 3D Shapes from 2D Images

(71) Applicant: Google LLC, Mountain View, CA (US)

(72) Inventors: Benjamin Sang Lee, San Francisco, CA (US); Matthew Douglas Hoffman, Brooklyn, NY (US); Tuan Anh Le, Cambridge, MA (US); Pavel Sountsov, Santa Clara, CA (US); Ryan Michael Rifkin, Oakland, CA (US); Christopher Gordon Suter, Brooklyn, NY (US)

(21) Appl. No.: 19/122,619

(22) PCT Filed: Oct. 20, 2023
(86) PCT No.: PCT/US2023/035603

§ 371 Date: Apr. 18, 2025

Related U.S. Application Data
(60) Provisional application No. 63/418,203, filed on Oct. 21, 2022.

(51) Int. Cl. G06T 15/04; G06T 7/55; G06T 7/90

(52) U.S. Cl. CPC G06T 15/04; G06T 7/55; G06T 7/90; G06T 2207/20081; G06T 2207/20084; G06T 2210/21

(57) ABSTRACT

Provided are computing systems, methods, and platforms that infer an object shape from an image using a neural radiance field (NeRF) model. A NeRF model can infer a 3D shape from a 2D image by performing a plurality of iterations to generate a plurality of sample 2D images of a 3D scene. For each iteration, an object code can be sampled from a posterior distribution of learned priors on NeRF models associated with the 3D scene, the object code can be processed with a hypernetwork to generate a set of NeRF weights from the object code, and a NeRF model with the set of NeRF weights predicted by the hypernetwork can generate a sample 2D image of the 3D scene. The sample 2D images generated during the iterations can be provided as an output.

### FIELD

The present disclosure relates generally to machine learning. More particularly, the present disclosure relates to computing systems, methods, and platforms that infer an object shape from an image.

### BACKGROUND

Machine learning is a field of computer science that includes the building and training (e.g., via application of one or more learning algorithms) of analytical models that are capable of making useful predictions or inferences on the basis of input data. Machine learning is based on the idea that systems can learn from data, identify patterns, and make decisions with minimal human intervention.

Neural radiance field (NeRF) models are machine learning models that can generate views of 3D shapes using 2D images with camera poses and images of a single scene. For instance. NeRF models can be used to infer point estimates of 3D models from 2D images. However, there may be uncertainty about the shapes of occluded parts of objects in an image. Therefore, improved techniques are desired to enhance the performance of NeRF models in inferring 3D shapes from 2D images.

### SUMMARY

Aspects and advantages of embodiments of the present disclosure will be set forth in part in the following description, or can be learned from the description, or can be learned through practice of the embodiments.

According to one example embodiment of the present disclosure, a computing system for inference for a neural radiance field (NeRF) model can include one or more processors. The computing system can further include one or more non-transitory computer-readable media that collectively store instructions that, when executed by the one or more processors, cause the computing system to perform operations. The operations can include generating a plurality of sample images of a scene. The operations can further include, for each iteration of a plurality of iterations, sampling an object code from a distribution comprising a posterior distribution of learned priors on NeRF models associated with the scene. The operations can further include, for each iteration of a plurality of iterations, processing the object code with a hypernetwork to generate a set of NeRF weights from the object code. The operations can further include, for each iteration of a plurality of iterations, generating, by a NeRF model having the set of NeRF weights predicted by the hypernetwork, a sample image of the scene. The operations can further include outputting the plurality of sample images, each sample image comprising the sample image of one of the iterations of the plurality of iterations.

According to another example embodiment of the present disclosure, a computer-implemented method for inference for a neural radiance field (NeRF) model can be performed by one or more computing devices and can include generating a plurality of sample images of a scene. The computer-implemented method can further include, for each iteration of a plurality of iterations, sampling an object code from a distribution comprising a posterior distribution of learned priors on NeRF models associated with the scene. The computer-implemented method can further include, for each iteration of a plurality of iterations, processing the object code with a hypernetwork to generate a set of NeRF weights from the object code. The computer-implemented method can further include, for each iteration of a plurality of iterations, generating, by a NeRF model having the set of NeRF weights predicted by the hypernetwork, a sample image of the scene. The computer-implemented method can further include outputting the plurality of sample images, each sample image comprising the sample image of one of the iterations of the plurality of iterations.

According to another example embodiment of the present disclosure, one or more non-transitory computer-readable media can collectively store instructions that, when executed by one or more processors of a computing system, cause the computing system to perform operations. The operations can include generating a plurality of sample images of a scene. The operations can further include, for each iteration of a plurality of iterations, sampling an object code from a distribution comprising a posterior distribution of learned priors on NeRF models associated with the scene. The operations can further include, for each iteration of a plurality of iterations, processing the object code with a hypernetwork to generate a set of NeRF weights from the object code. The operations can further include, for each iteration of a plurality of iterations, generating, by a NeRF model having the set of NeRF weights predicted by the hypernetwork, a sample image of the scene. The operations can further include outputting the plurality of sample images, each sample image comprising the sample image of one of the iterations of the plurality of iterations.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of implementations directed to one of ordinary skill in the art is set forth in the specification, which makes reference to the appended figures, in which:

FIGS. 1A, 1B, and 1C depict a block diagram of an example computing system that performs inference for a neural radiance field (NeRF) model according to example embodiments of the present disclosure.

FIGS. 2A and 2B depict a block diagram of an example neural radiance field (NeRF) model according to example embodiments of the present disclosure.

FIG. 3 depicts a block diagram of example images of an example neural radiance field (NeRF) model according to example embodiments of the present disclosure.

FIG. 4 depicts a flow chart diagram of an example method to perform inference for a neural radiance field (NeRF) model according to example embodiments of the present disclosure.

Reference numerals that are repeated across plural figures are intended to identify the same features in various implementations.

### DETAILED DESCRIPTION

### Overview

Generally, the present disclosure is directed to computing systems, methods, and platforms that perform inference for a neural radiance field (NeRF) model. In particular, the NeRF model can be used to infer the 3D shape of objects from a 2D image, including the unseen parts of the object. A prior probability distribution can be formed over training scenes, and given one or few images of a new scene from the same class, the method can sample from the posterior distribution that realistically completes the given image(s). The samples can be used to estimate the inherent uncertainty of unobserved views, which can be useful for planning and decision problems (e.g., in robotics or autonomous vehicles).

A model trained using a variational autoencoder can sample from a posterior over NeRFs that are consistent with a set of input views. The sampling can be performed using Hamiltonian Monte Carlo (HMC) to sample from the posterior and a temperature-annealing strategy can be employed in the HMC sampler to make it more robust to isolated modes.

A two-stage hypernetwork-based decoder can be used to represent each object using a smaller NeRF, which can reduce the per-pixel rendering costs and the cost of iterative test-time inference. The raw weight of each object's NeRF representation can be generated by the hypernetwork, and the raw weights can be treated as random variables to be inferred, which allows for high-fidelity reconstruction of objects. A NeRF model with the set of weights predicted by the hypernetwork can be used to generate a sample image. Multiple iterations of sampling from the posterior and processing with the hypernetwork can be performed to generate multiple sample images.

Existing approaches can infer reasonable point estimates from a single image, but they fail to account for the uncertainty about the shape and appearance of unseen parts of the object. A neural network can map from 5D position-direction inputs to a 4D color-density output, and this NeRF can be plugged into a volumetric rendering equation to obtain images of the field from various viewpoints, and trained to minimize the mean squared error in RGB space between the rendered images and the training images. However, this procedure works when the training images are taken from enough viewpoints to fully constrain the geometry of the scene or the object being modeled but fails when only one or two images are available, so 3D geometry cannot be inferred from a single 2D image without prior knowledge about plausible shapes.

The computing systems, methods, and platforms of the present disclosure can produce reasonable point estimates of a single low-information view of a novel object's shape and appearance, and can also estimate the range of shapes and appearance that are consistent with the available data. High-fidelity reconstruction and robust characterization of uncertainty within the NeRF framework can be simultaneously achieved as well.

Technical effects of the example computing systems, methods, and platforms of the present disclosure include a sampling that is more robust to isolated modes that arise from the non-log-concave likelihood. Per-pixel rendering costs and the costs of iterative test-time inference are also reduced by using a two-stage hypernetwork-based decoder rather than a single-network strategy such as latent concatenation. Each object can also be represented using a smaller NeRF. The latent-code bottleneck is also eliminated, allowing for high-fidelity reconstruction of objects. Hypernetworks can also perform as well as attention mechanisms, but hypernetworks are less expensive, especially for iterative posterior inference. Test-time of NeRF weights alongside latent codes can also improve reconstructions, especially when input images are highly informative. The shape and appearance uncertainty for open-ended classes of 3D objects can also be characterized, and the models of the present disclosure can condition on arbitrary sets of pixels and camera positions.

With reference now to the Figures, example implementations of the present disclosure will be discussed in greater detail.

### Example Devices and Systems

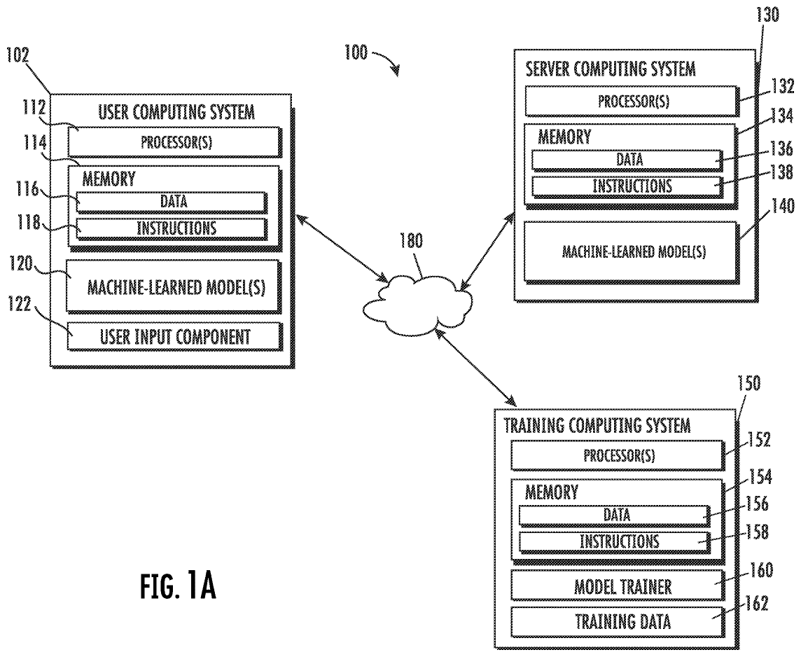

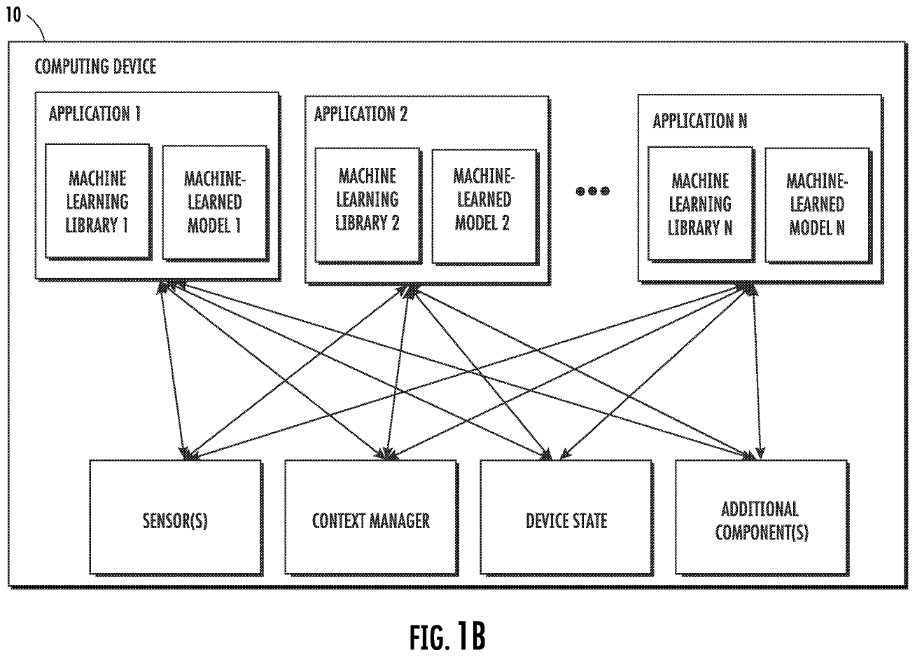

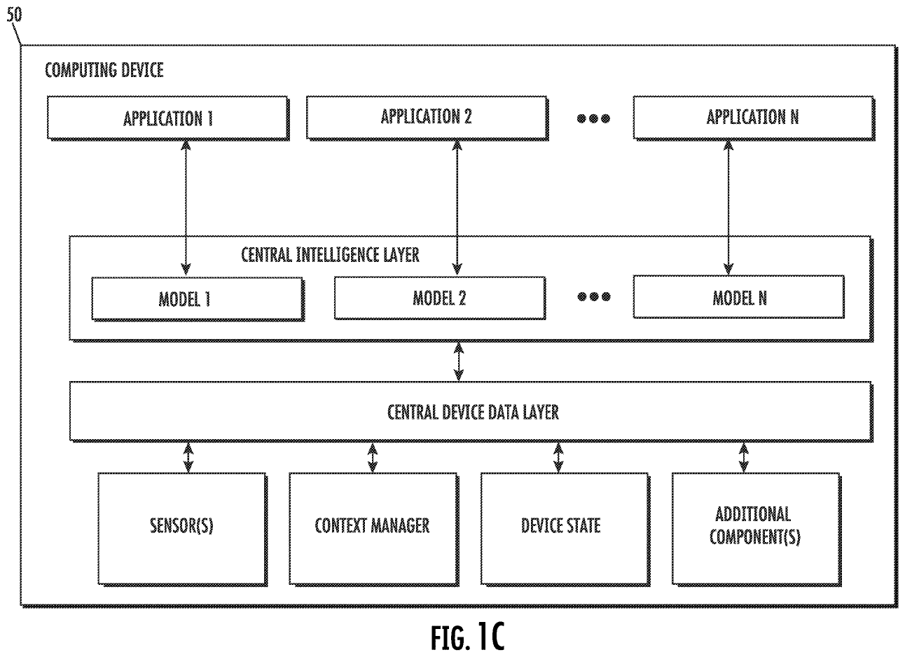

FIG. 1A depicts a block diagram of an example computing system 100 that performs inference for a neural radiance field (NeRF) model according to example embodiments of the present disclosure. The computing system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

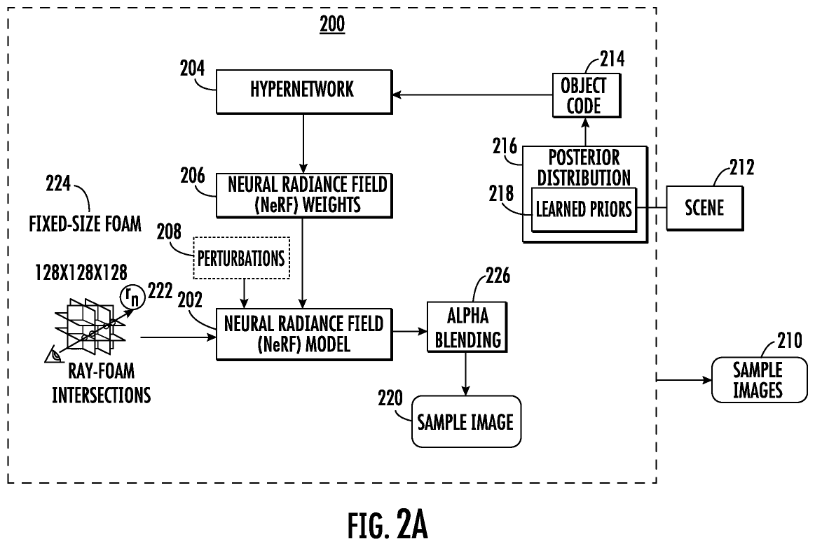

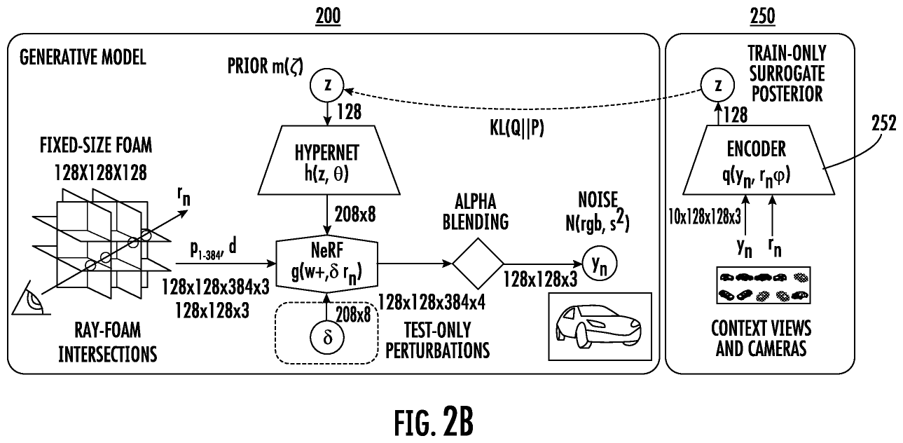

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). As another example, example machine-learned models can include diffusion models. Example machined-learned models 120 are discussed with reference to FIGS. 2A and 2B.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel inference across multiple instances of a neural radiance field (NeRF) model).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 130 as a portion of a web service (e.g., an image rendering service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example machine-learned models 140 are discussed with reference to FIGS. 2A and 2B.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM. ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained. In particular, the model trainer 160 can train the machine-learned models 120 and/or 140 based on a set of training data 162. The training data 162 can include, for example, various images.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP. HTTP, SMTP, FTP), encodings or formats (e.g., HTML. XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

FIG. 1A illustrates one example computing system that can be used to implement the present disclosure. Other computing systems can be used as well. For example, in some implementations, the user computing device 102 can include the model trainer 160 and the training data 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Generative Process and Test-Time Inference

FIGS. 2A and 2B depict a block diagram of an example neural radiance field (NeRF) model 202 and generative process 200 and test-time inference procedure according to example embodiments of the present disclosure. A plurality of iterations of the generative process 200 can be performed to generate a plurality of sample images 210 of a scene 212, each sample image of the plurality of sample images 210 generated during one of the plurality of iterations of the generative process 200 (e.g., sample image 220). Given one or a few images of a new scene 212 from the same class, the generative process 200 can sample from a posterior distribution of NeRFs that realistically complete the given images, and the samples can be used to estimate the inherent uncertainty of unobserved views.

Let f_{w}(x, v) be a function that, given some neural network weights w, a position x∈ [symbol] and a viewing direction v∈ [symbol] , outputs a density σ∈ [symbol] and an RGB color c∈[0,1]³. Let g(w, r) be a rendering function that maps from a ray r and the conditional field f_{w} to a color y∈[0,1]³ by querying f_{w} at various points along the ray r.

Assume that, given a set of rays r_{1:N}, a set of pixels y_{1:N} is generated by the following process: sample an abstract object code z (object code 214) from a posterior distribution 216 of learned priors 218 associated with the scene 212 (e.g., an output of a invertible real-valued non-volume preserving map, such as a standard normal distribution pushed forward through an invertible RealNVP map m), run it through a hypernetwork 204 (a neural network that generates weights for another neural network) to get a set of NeRF weights w (NeRF weights 206), perturb those weights with low-variance Gaussian noise (perturbations 208), render the resulting model (NeRF model 202), and add some pixelwise Gaussian noise to result in a sample image 220 (e.g., the set of pixels y_{1:N}). More formally, \tilde{z}˜ [symbol] (0, I); z=m(\tilde{z}; ζ); w=h(z; θ); δ˜ [symbol] (0, I); \tilde{w}=w+\sqrt{αδ}; yₙ˜ [symbol] (g(\tilde{w}, rₙ), s²), where m(⋅; ζ) is an invertible RealNVP function with parameters ζ, z∈ [symbol] (e.g., object code 214) is a latent code that summarizes the object's shape and appearance, h(z; θ) is the hypernetwork 204 with parameters θ that maps from codes z (e.g., object code 214) to NeRF weights w (NeRF weights 206), and α and s² are scalar variance parameters.

The architecture used in the generative process 200 is a hypernetwork 204 to generate a full set of NeRF weights 206. Existing works instead concatenate the latent code z to the input and activations. The hypernetwork approach of the present disclosure generalizes the latent-concatenation approach, and recent results argue that hypernetworks should allow for the achievement of a similar level of expressivity to the latent-concatenation strategy using a smaller architecture for f—intuitively, putting many parameters into a large, expressive hypernetwork makes it easier to learn a mapping to a compact function representation. This leads to large savings at both train and test time if there is a need to render many rays per object since the cost of an expensive mapping from z to w over hundreds or thousands of ray's can be amortized, each of which requires many function evaluations to render. For example, a four-hidden-layer architecture with 64 hidden units can be used, which results in rendering cost savings per function evaluation. Performing inference over the raw NeRF weights can increase the quality and realism of a conditioned-on view reconstruction without having negative effects on held-out view reconstruction performance. Adding raw NeRF weights as latent variables can increase the support with a positive prior over the radiance fields which lets the system adapt to novel views given sufficiently informative observations.

This generative process also allows for small perturbations 208 of the weights w (NeRF weights 206), which ensures that the prior on NeRF models has positive support on the full range of functions {f_{\tilde{w}}|\tilde{w}∈ [symbol] }, rather than the much smaller manifold of functions {f_{w}|w=h (z; θ) for some z∈ [symbol] }. A variance α=0.025² on the weights 206 can be applied to be small enough not to introduce noticeable artifacts, but large enough that the likelihood signal from a high-resolution image can overwhelm the prior preference to stay near the manifold defined by the mapping from z to w. Even if the range of the hypernetwork 204 does not include a parameter vector w that accurately represents an object (e.g., due to limited capacity or overfitting), the posterior p(\tilde{w}|r, y) will still concentrate around a good set of parameters \tilde{w} with more data. An additional distribution on perturbations of posterior NeRF weights allows for better reconstructions when there are many or more informative images.

Hamiltonian Monte Carlo (HMC), a gradient-based Markov chain Monte Carlo (MCMC) method that uses momentum to mitigate poor conditioning of the target log-density function, can be used at inference time. With HMC, rather than sample in z, \tilde{w} space, the non-centered parameterization and sample from p(\tilde{z}, δ|y, r) can be used since the joint prior for \tilde{z} and δ is a well-behaved spherical normal.

HMC is a powerful MCMC algorithm, but it can still get trapped in isolated modes of the posterior. Running multiple chains in parallel can provide samples from multiple modes, but it may be that some chains find, but cannot escape from, modes that have negligible mass under the posterior. A conditioning problem also arises in inverse problems where some degrees of freedom are poorly constrained by the likelihood: as the level of observation noise decreases it becomes necessary to use a smaller step size, but the distance in the latent space between independent samples may stay almost constant. To make the sampling procedure of the present disclosure more robust to minor modes and poor conditioning, a temperature-annealing strategy is used. Over the course of T HMC iterations, reduce the observation-noise scale s logarithmically from a high initial value s₀ to a low final value s_{T}, with

$${s}_{t} = {s}_{0}^{( T - t ) / T} {s}_{T}^{t / T}$$

(for a Gaussian likelihood, this is equivalent to annealing the “temperature” of the likelihood). That is, start out targeting a distribution that is close to the prior (e.g., the posterior distribution 216), and gradually increase the influence of the likelihood until the posterior is being targeted. The step size can also be annealed so that it is proportional to sₜ. This procedure lets the sampler explore the latent space thoroughly at higher temperatures before settling into a state that achieves low reconstruction error. This annealing procedure can yield more-consistent results than running HMC at a low fixed temperature. In particular, the annealed-HMC procedure's samples can be both more consistent and more faithful to the ground truth, allowing the HMC to avoid low-mass modes of the posterior and focus on more plausible explanations of the data. Annealed-HMC also can consistently find solutions that are consistent with the conditioned-on view; while a fixed-temperature HMC does not.

NeRFs generally employ a stochastic quadrature approximation of the rendering integral. Although this procedure is deterministic at test time, its gradients are not reliable enough to use in HMC. While stochastic-gradient methods are robust to the noise from this procedure, standard HMC methods are not. Stochastic-gradient HMC methods do exist, but require omitting the Metropolis correction, which perturbs the stationary distribution unless one uses a small step size and/or can accurately estimate the high-dimensional covariance of the gradient noise. The approach of the present disclosure instead uses a simplified renderer. All density can be assumed as concentrated in a “foam” 224 consisting of the surfaces of a 128×128×128 lattice of cubes. Since there is no density inside the cubes, a ray 222 can be rendered by enumerating all ray-cube intersection points, computing opacities and colors at each intersection, and alpha-compositing the result (alpha blending 226). This simplification avoids the need to map the latent code to grid vertices. Rendering a ray requires at most 128×3=384 function evaluations (not 1283). The renderer of the present disclosure works well with HMC, while HMC with the standard quadrature scheme cannot achieve high acceptance rates.

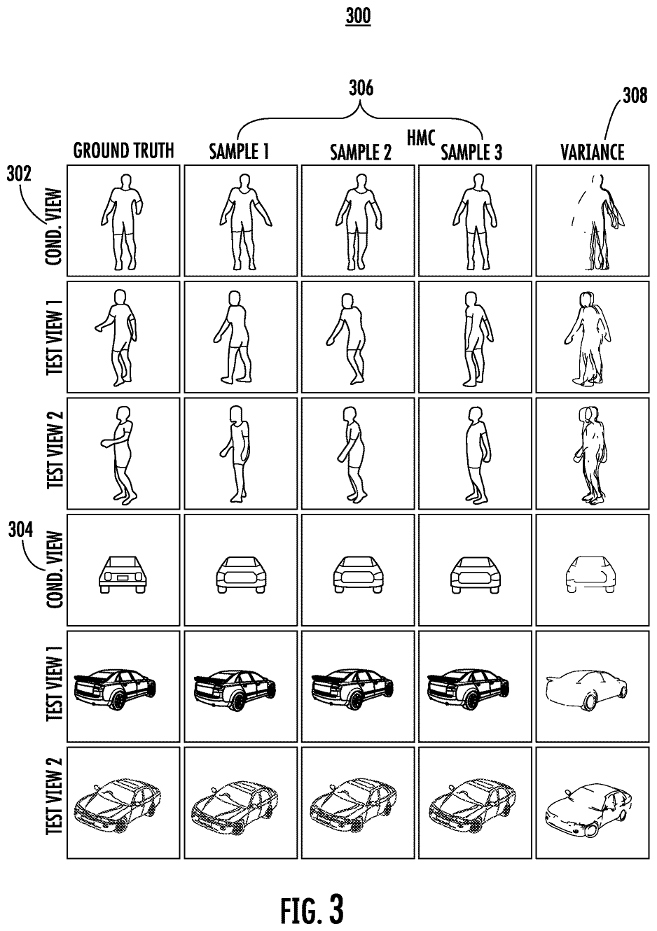

FIG. 3 depicts a block diagram of example images 300 of an example neural radiance field (NeRF) model 202 according to example embodiments of the present disclosure. Conditioned on either the left-hand view of a generative human body (GHUM) 302 or a back view of a car 304, the HMC method produces samples 306 that are realistic, consistent with the conditioned-on view of a GHUM 302, and diverse as shown by the per-pixel variance 308.

### Example Training Procedure

FIGS. 2A and 2B depict a block diagram of an example neural radiance field (NeRF) model 202 and generative process 200 and training procedure 250 according to example embodiments of the present disclosure. Training can be performed on a large dataset to learn the priors and the hypernetwork. NeRF models for inference using the computing systems, methods, and platforms of the present disclosure can be trained using a variational autoencoder strategy with a simplified generative process that omits the perturbation from w to \tilde{w}:z˜ [symbol] (0, I); z=m (\tilde{z}; ζ) w=h(z; θ); yₙ˜ [symbol] (g(w, rₙ), s²). These perturbations can be omitted at training time so that the model can learn hypernet parameters θ and RealNVP parameters ζ that can explain the training data well without relying on perturbations. The perturbations δ are intended to allow the model as an inference-time “last resort” to explain factors of variation that were not in the training set: at training time. δ should not explain away variations that could be explained using z, since the model may not learn a meaningful prior on δ.

To compute a variational approximation q(z|y, r) to the posterior p(z|y, r), a convolutional neural network (CNN) can be used to map from each RGB image and camera matrix to a diagonal-covariance K-dimensional Gaussian potential, parameterized as locations μⱼ and precisions τⱼ for the jth image. These potentials can approximate the influence of the likelihood function on the posterior. These J potentials can be combined with a learned “prior” potential parameterized by location μ₀ and precisions τ₀ via the Gaussian update formulas

$$\hat{τ} = {\sum }_{j = 0}^{J} {τ}_{j} ; \hat{μ} = {\hat{τ}}^{- 1} {\sum }_{j = 0}^{J} {τ}_{j} {μ}_{j} and set q ( {z}_{k} \vert y , r ) = 𝒩 ( {z}_{k} ; {\hat{μ}}_{k} , {\hat{τ}}_{k}^{- 1} ) .$$

The encoder parameters φ, the hypernet parameters θ, and the RealNVP parameters ζ can be trained by maximizing the evidence lower bound (ELBO) using Adam:

$$\begin{matrix}ℒ = {𝔼}_{q} [ log p ( y \vert z , r ) - log \frac{q ( z \vert y , r )}{p ( z )} ] \\ = {𝔼}_{q} [ log p ( y \vert z , r ) - log \frac{q ( z \vert y , r )}{𝒩 ( {m}^{- 1} ( z ) ; 0 , I ) \vert \frac{d {m}^{- 1}}{dz} \vert} ]\end{matrix} .$$

For example, training can be performed on minibatches of eight objects and ten randomly selected images per object to give the encoder 252 enough information to infer a good latent code z. The encoder 252 sees all ten images, but to reduce rendering costs, an unbiased estimate of the log-likelihood log p(y|z, r) can be computed from a random sub-sample of 1024 rays per object. As a result of this training procedure, a good RealNVP prior on codes and reconstructing training examples accurately can be learned. For the encoder 252, each potential of the variational posterior can be modeled as a diagonal covariance Gaussian with mean μ and scale σ computed via a CNN.

### Example Architectures

For each object's NeRF, two MLPs (multilayer perceptron), each with two hidden layers of width 64, can be used. The first MLP can map from position to density and the second MLP can map from position, view direction, and density to color. All positions and view directions can be first transformed using a 10th-order sinusoidal encoding. The number of parameters per object can be 20.868, relatively few for a NeRF. The NeRF model can be split into two sub-networks, one for density and one for color. The input position p and ray direction d can be encoded using a 10th order sinusoidal positional encoding. For a scalar component of the input vector xᵢ a feature can be produced: fᵢ={sin(2^{j}πxᵢ+0.5 k)|j∈[0,10), k∈[0,1]}. This array can be flattened and concatenated with the original input value to produce a 21-element feature vector for each xᵢ. To convert output density σ∈ [symbol] to α∈[0,1] it is squashed as α=1−exp(−σ/128), where 128 is the grid size.

The RealNVP network that implements the mapping from \tilde{z} to z can comprise two pairs of coupling layers. Each coupling layer can be implemented as an MLP with one 512-unit hidden layer that shifts and rescales half of the variables conditioned on the other half: each pair of coupling layers updates a complementary set of variables. The variables can be randomly permuted after each pair of coupling layers. The RealNVP m(\tilde{z}; ζ) can comprise four RealNVP blocks that act on a latent vector split into two parts, and the split sense is reversed between the RealNVP blocks.

The hypernetwork that maps from the 128-dimensional code z to the 20,868 NeRF weights can be a two-layer 512-hidden-unit MLP. This mapping uses a similar number of FLOPs to render a few pixels. The hypernetwork h(z; θ) can be an MLP with two shared hidden layers, followed by a learnable linear projection and reshape operations to produce the parameters of the NeRF networks.

The encoder network can apply a 5-layer CNN to each image and a two-layer MLP to its camera-world matrix, then linearly map the concatenated image and camera activations to locations and log-scales for each image's Gaussian potential. All networks can use ReLU nonlinearities.

### Example Methods

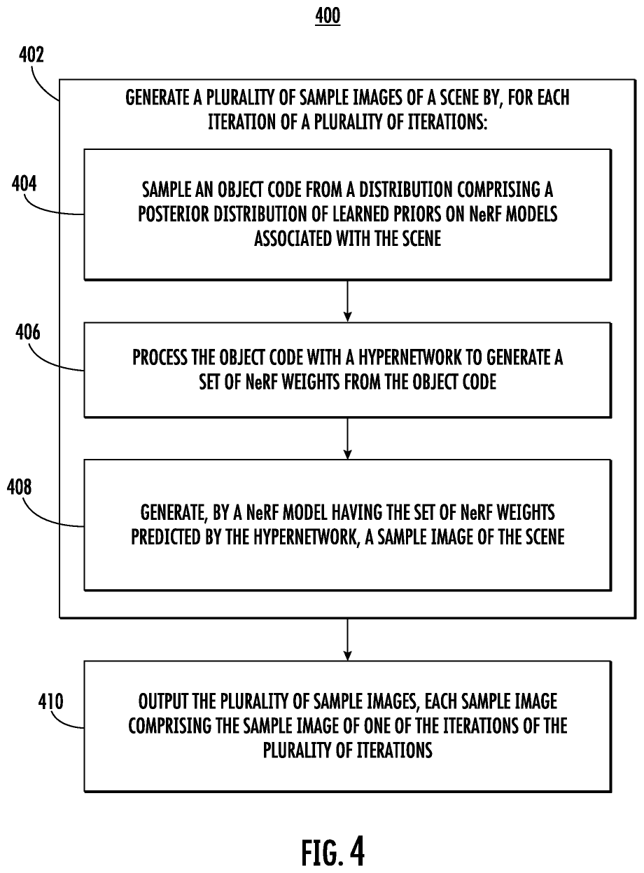

FIG. 4 depicts a flow chart diagram of an example method to perform according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

At 402, a computing system generates a plurality of sample images of a scene by, for each iteration of a plurality of iterations, performing the steps 404, 406, and 408. In some examples, for each iteration of the plurality of iterations, the computing system obtains a ray of the sample image, enumerates each ray-cube intersection point of a foam comprising surfaces of a lattice of cubes, calculates opacities and colors at each ray-cube intersection point, and renders the ray of the sample image by alpha compositing the calculated opacities and colors at each ray-cube intersection point.

At 404, the computing system, for each iteration of the plurality of iterations, samples an object code from a distribution comprising a posterior distribution of learned priors on NeRF models associated with the scene. In some examples, the object code summarizes a shape and an appearance of one or more objects included in the scene. In some examples, the posterior distribution of learned priors is generated as an output of an invertible real-valued non-volume preserving map. In some examples, the computing system samples the object code from the distribution by applying a Hamiltonian Monte Carlo algorithm, wherein a target distribution is the posterior distribution. In some examples, the computing system applies the Hamiltonian Monte Carlo algorithm by reducing an observation-noise scale logarithmically from a high initial value to a low final value.

At 406, the computing system, for each iteration of the plurality of iterations, processes the object code with a hypernetwork to generate a set of NeRF weights from the object code. In some examples, subsequent to processing the object code with the hypernetwork to generate the set of NeRF weights from the object code, the computing system perturbates the set of NeRF weights with Gaussian noise.

At 408, the computing system generates, for each iteration of the plurality of iterations, by a NeRF model having the set of NeRF weights predicted by the hypernetwork, a sample image of the scene. In some examples, the posterior distribution of learned priors, the hypernetwork, and the NeRF models are trained jointly in the form of a variational autoencoder.

At 410, the computing system outputs the plurality of sample images, each sample image comprising the sample image of one of the iterations of the plurality of iterations. In some examples, the computing system estimates, based on the plurality of sample images, an uncertainty of an unobserved view of the image. In some examples, the computing system estimates the uncertainty of the unobserved view of the image by computing a variance from the plurality of sample images.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method comprising:
generating a plurality of sample images of a scene by, for each iteration of a plurality of iterations:
sampling an object code from a distribution comprising a posterior distribution of learned priors on neural radiance field (NeRF) models associated with the scene;
processing the object code with a hypernetwork to generate a set of NeRF weights from the object code; and
generating, by a NeRF model having the set of NeRF weights predicted by the hypernetwork, a sample image of the scene; and
outputting the plurality of sample images, each sample image comprising the sample image of one of the iterations of the plurality of iterations.

2. The computer-implemented method of claim 1, wherein sampling the object code from the distribution comprises applying a Hamiltonian Monte Carlo algorithm, wherein a target distribution is the posterior distribution.

3. The computer-implemented method of claim 2, wherein applying the Hamiltonian Monte Carlo algorithm comprises reducing an observation-noise scale logarithmically from a high initial value to a low final value.

4. The computer-implemented method of claim 1, further comprising:
subsequent to processing the object code with the hypernetwork to generate the set of NeRF weights from the object code, perturbing the set of NeRF weights with Gaussian noise.

5. The computer-implemented method of claim 1, further comprising:
for each iteration of the plurality of iterations:
obtaining a ray from among a set of rays associated with the scene;
enumerating each ray-cube intersection point of a foam comprising surfaces of a lattice of cubes;
calculating opacities and colors at each ray-cube intersection point; and
rendering the ray by alpha compositing the calculated opacities and colors at each ray-cube intersection point.

6. The computer-implemented method of claim 1, further comprising:
estimating, based on the plurality of sample images, an uncertainty of an unobserved view of the image.

7. The computer-implemented method of claim 6, wherein estimating, based on the plurality of sample images, the uncertainty of the unobserved view of the image comprises computing a variance from the plurality of sample images.

8. The computer-implemented method of claim 1, wherein the object code summarizes a shape and an appearance of one or more objects included in the scene.

9. The computer-implemented method of claim 1, wherein the posterior distribution of learned priors is generated as an output of an invertible real-valued non-volume preserving map.

10. The computer-implemented method of claim 1, wherein the posterior distribution of learned priors, the hypernetwork, and the NeRF models are trained jointly in the form of a variational autoencoder.

11. A computing system comprising:
one or more processors; and
one or more non-transitory computer-readable media that collectively store instructions that, when executed by the one or more processors, cause the computing system to perform operations, the operations comprising:
generating a plurality of sample images of a scene by, for each iteration of a plurality of iterations:
sampling an object code from a distribution comprising a posterior distribution of learned priors on neural radiance field (NeRF) models associated with the scene:
processing the object code with a hypernetwork to generate a set of NeRF weights from the object code; and
generating, by a NeRF model having the set of NeRF weights predicted by the hypernetwork, a sample image of the scene; and
outputting the plurality of sample images, each sample image comprising the sample image of one of the iterations of the plurality of iterations.

12. The computing system of claim 11, wherein sampling the object code from the distribution comprises applying a Hamiltonian Monte Carlo algorithm, wherein a target distribution is the posterior distribution.

13. The computing system of claim 12, wherein applying the Hamiltonian Monte Carlo algorithm comprises reducing an observation-noise scale logarithmically from a high initial value to a low final value.

14. The computing system of claim 11, further comprising:
subsequent to processing the object code with the hypernetwork to generate the set of NeRF weights from the object code, perturbing the set of NeRF weights with Gaussian noise.

15. The computing system of claim 11, further comprising:
for each iteration of the plurality of iterations:
obtaining a ray from among a set of rays associated with the scene;
enumerating each ray-cube intersection point of a foam comprising surfaces of a lattice of cubes;
calculating opacities and colors at each ray-cube intersection point; and
rendering the ray by alpha compositing the calculated opacities and colors at each ray-cube intersection point.

16. The computing system of claim 11, further comprising:
estimating, based on the plurality of sample images, an uncertainty of an unobserved view of the image.

17. The computing system of claim 16, wherein estimating, based on the plurality of sample images, the uncertainty of the unobserved view of the image comprises computing a variance from the plurality of sample images.

18. The computing system of claim 11, wherein the object code summarizes a shape and an appearance of one or more objects included in the scene.

19. The computing system of claim 11, wherein the posterior distribution of learned priors is generated as an output of an invertible real-valued non-volume preserving map.

20. The computing system of claim 11, wherein the posterior distribution of learned priors, the hypernetwork, and the NeRF models are trained jointly in the form of a variational autoencoder.

21. One or more non-transitory computer-readable media that collectively store instructions that, when executed by one or more processors of a computing system, cause the computing system to perform operations, the operations comprising:
generating a plurality of sample images of a scene by, for each iteration of a plurality of iterations:
sampling an object code from a distribution comprising a posterior distribution of learned priors on neural radiance field (NeRF) models associated with the scene;
processing the object code with a hypernetwork to generate a set of NeRF weights from the object code; and
generating, by a NeRF model having the set of NeRF weights predicted by the hypernetwork, a sample image of the scene; and
outputting the plurality of sample images, each sample image comprising the sample image of one of the iterations of the plurality of iterations.
